(19) United States
(12) Patent Application Publication
(10) Pub. No.: US 2011/0068572 A1
(43) Pub. Date: Mar. 24, 2011

(54) SWAGED COUPLING FOR HIGH-PRESSURE HOSE, HIGH-PRESSURE HOSE WITH SWAGED COUPLING, AND METHOD FOR MAKING THE SAME

(75) Inventors: László Nacsa, Algyo (HU); Gyula Bétéri, Erd (HU); József David, Szeged (HU); Tamás Katona, Algyo (HU); Tibor Nagy, Budapest (HU)

(73) Assignee: ContiTech Rubber Industrial Gumiipari KFT, Szeged (HU)

(21) Appl. No.: 12/888,630

(22) Filed: Sep. 23, 2010

(30) Foreign Application Priority Data
Sep. 23, 2009 (HU) P0900601

(51) Int. Cl. F16L 33/00; B23P 17/04

(52) U.S. Cl. 285/256; 29/505

(57) ABSTRACT

A hose coupling for high-pressure hoses includes a stem and a ridged outer ferrule connected to the stem, wherein a staggered portion is disposed on the stem in the proximity of the connection of the stem and the ridged outer ferrule, where the diameter of the staggered portion is larger than the diameter of the stem, and the staggered portion has an undercut and a cutting edge. Also, a high-pressure hose fitted with the above swaged coupling, and a method for producing it. In the method, prior to swaging, the cover of the hose is removed at the portion where the cover is in connection with the ridges of the ridged outer ferrule of the hose coupling, and the hose liner and an optionally included load distribution textile ply or cord fabric ply are also removed from the hose end before swaging at a length not longer than the length of the staggered portion of the stem.

### RELATED APPLICATIONS

This application claims the benefit of priority under 35 U.S.C. 119(b) of Hungarian Application Serial No. P0900601, filed Sep. 23, 2009.

### FIELD

The invention relates to a swaged coupling for high-pressure hoses, and a hose with swaged coupling, particularly a hose reinforced with helical steel (wire or cable) reinforcing plies. The invention also covers a method for producing high-pressure hoses fitted with the above swaged coupling. In the context of the present specification the term “high-pressure hose” refers to hoses with an operating pressure higher than 10 MPa, and the term “large-diameter hose” refers to hoses with an inside diameter of 50 mm or larger.

### BACKGROUND

It is well known in the art that high-pressure hoses are produced with many different structural arrangements, such as applying braiding, steel tendon and profile rein-forcement, as well as helically wound reinforcing plies. These solutions are well known for people skilled in the art, with the description of several arrangements being laid down in standards.

High pressure hoses are connected by means of metal couplings that have to perform at least three functions: provide sealing between the liner and the coupling, bear radial forces arising from internal pressure, and transfer axial forces from the reinforcing ply(plies) to the coupling. The prior art includes several types of hose couplings. Of these only the so called “swaged” or “crimped” couplings are discussed in relation to the present specification.

The swaging or crimping operation may be carried out in a number or ways. For instance, the coupling can be swaged “from inside” by pulling a die (so-called dolly) having a diameter larger than the inside diameter of the coupling through it, or “from outside”, by pulling the coupling through a die having an opening smaller than the diameter of the coupling, or may be crimped from outside utilizing a segmented crimping die. In A. C. Evans's book entitled Hose Technology (2nd ed., Appl. Sci. Publ. London 1979) a number of swaged and crimped hose coupling types and swaging and crimping methods are described. In English-language literature a distinction is made between two types method for attaching the coupling to the hose: swaging (with circumferential die) and crimping (with segmented die). Though swaged couplings have been in use for more than 50 years (e.g. a swaged hose coupling is disclosed in U.S. Pat. No. 2,430,921 granted in 1943), there still exist high-pressure hoses to which it is not possible to attach swaged or crimped couplings utilizing prior art solutions. These include large-diameter oil drilling hoses made from rubber reinforced with helically wound steel wires or twisted steel strands (called steel cables) that are regularly subjected to cyclic load at high temperature, such as rotary drilling hoses and hoses for transferring drilling mud specified in the standard API Spec. 7K 4th edition, Addendum 2 FSL-2, with an inside diameter of 2-6″ (51-152 mm), especially the so-called “grade E” hoses that have a rated operating pressure of 51.7 MPa. Furthermore, no solution exists for attaching swaged or crimped coupling to cementing and blowout preventer hoses that have a similar arrangement but even higher operating pressure.

As it is well known in the art, the angle of lay of reinforcing plies of rubber hoses reinforced with steel wires or cables usually decreases from the innermost ply to the outside. (The angle of lay is measured against a circular cross section taken perpendicularly to the hose axis.) The angle of lay for the plies of the hose to be manufactured is usually exactly predetermined, for instance the document HU 198 781, and the corresponding U.S. Pat. No. 4,860,798 disclose hoses comprising as many as 2, 4, 6, or even 8 spirally laid reinforcing plies. The angle of lay of the plies decreases significantly (even from 55° to 16°)from the inside to the outside.

As it is well known for those skilled in cold forming, during the swaging operation performed from inside, the inner stem of the coupling undergoes not only radial expansion but axial contraction, and similarly, the outer ferrule undergoes radial shrinking and axial expansion. This phenomenon is taken into account when designing hose couplings, for instance in case of solutions applying interlocking “wavelike” surfaces.

According to these solutions, the reinforcing plies are grabbed between concentric sinusoidal wavelike surfaces during the swaging operation. Such a solution is disclosed in FIGS. 2-7, 9, and 11 of Hungarian patent specification HU 176,336.

International patent specification published as WO 98/036204 discloses an arrangement where the relative position of wavelike portions of the stem and the outer ferrule is such that the peaks of the wave on the stem fit to the troughs of the wave on the outer ferrule. The outer ferrule has circumferential ribs. In the above disclosure it is suggested that the stem is swaged outwards, and the outer ferrule is swaged inwards. However, this solution has not proven feasible in actual practice.

The documents US 2003/0205898 A1 and US 20070157443 disclose a solution that is in many respects similar to the above one. The hose couplings described in these documents are intended to be attached to hoses with a pressure burst rating larger than 12,500 psi (86.25 MPa), the stem and outer ferrule of the coupling having sinusoidal wavelike surfaces that come into the desired interlocking peak-trough position after swaging. FIGS. 1-9 of the documents show generally applied prior art swaged couplings that have a serrated stem and an outer ferrule having ridges (or lands). The ferrule of this coupling is swaged from the outside. The document U.S. Pat. No. 5,607,191 describes basically the same solution. The swaged coupling disclosed in the document GB 2,220,242 A also contains means that force the reinforcing plies of the hose to take a wavelike shape. Two ribs are disposed on the inner stem, with corresponding grooves being disposed on the outer ferrule. A small length of the liner is removed from the hose end to provide a metal-to-metal contact between the coupling and the hose body.

A general feature of the above solutions is that the cover has to be removed from the reinforcing plies at almost the entire length of the outer ferrule of the coupling, especially if the wall of the cover is thicker than 2-3 mm, and the cover contains one or more textile plies, as it is the case with high-pressure rotary drilling and cementing hoses. In specific cases it may become necessary to remove a length of the liner, such as in the solution according to patent specification U.S. Pat. No. 3,347,571. Hydraulic hoses have thin cover and liner, and they do not contain textile plies below and above the reinforcing ply. The document U.S. Pat. No. 4,564,223 describes a coupling having teeth that penetrate through the thin cover and liner during swaging or crimping, biting directly into the metal reinforcing ply with at least two oppositely arranged annular teeth This solution, however, is not applicable for large-diameter high pressure hoses having multiple textile layers for load distribution under the helically wound reinforcing plies.

In everyday practice it often happens that under cycling pressure—especially at high temperature—the coupling comes off the hose. Our model calculations (confirmed by practical experience) indicate that in hoses having helical reinforcing plies the highest axial forces are borne by the bottom ply wound at a higher angle of lay. However, in most prior art swaged couplings the coupling has a metal-to-metal grip only on the upper ply. This causes the bottommost helical reinforcing ply, which is not in direct connection with the coupling, and yet bears most of the axial load, to slip under cycling pressure sooner or later, resulting in a leaking hose.

Another frequently occurring problem is that the hose starts leaking after prolonged operation. In known swaged couplings sealing is provided by the pressure produced in the liner during the swaging operation. However, rubber is prone to undergo permanent deformation (relaxation), which causes the stress built up in the liner to gradually decrease. This process becomes important for hoses operating at high temperatures.

### SUMMARY

The objective of the invention is therefore to provide a swaged coupling and high-pressure hose fitted therewith that prevents the bottom reinforcing ply from slipping, and ensures tight sealing under the conditions of large number of high pressure cycles and high temperature. The inventive objective is fulfilled by providing metal-to-metal bonding between the coupling and the first steel cable ply, and by providing the coupling with a self-sealing capable undercut.

For easier understanding of the following detailed description it has to be noted that the wire (or steel cable) plies are numbered outward from the innermost ply. Therefore the term “first ply” refers to the innermost one.

The essential features of the hose coupling according to the invention are that it comprises a stem and a ridged outer ferrule connected by a joint to the stem, and a staggered portion is disposed on the stem in the proximity of the connection of the stem and the ridged outer ferrule, where the diameter of the staggered portion is larger than the diameter of the stem, and the staggered portion has an undercut and a cutting edge. The length of the staggered portion disposed on the stem is smaller than half of the length of the stem section extending between the end of the stem and the connection of the stem and the outer ferrule.

The staggered portion (having a diameter larger than the inner stem), the cutting edge, and the undercut may be made from the material of the stem, or may be implemented as an insert that can be pulled on the outer surface of the stem.

According to a preferred embodiment the inner stem has a serrated staggered portion.

It is also preferable if the teeth of the serrated staggered portion of the inner stem lie in the same plane as the corresponding ridges of the outer ferrule after the swaging operation.

The solution according to the invention can be applied for hoses having more than two, for instance four or six reinforcing plies, in which case the plies preferably have staggered portions. The term “staggered portion”, used in relation to hoses having more than two reinforcing plies, refers to portions from where the reinforcing plies are removed pair by pair before attaching the coupling on the hose.

The high-pressure hose fitted with the swaged coupling according to the invention is characterized by that before swaging, the cover of the hose is removed at the portion where the cover is in connection with the ridges of the ridged outer ferrule of the hose coupling, and the hose liner and the optionally included load distribution textile ply or cord fabric ply are also removed from the hose end before swaging at a length not longer than the length of the staggered portion of the stem.

Preferably, in case of the hoses with four or more reinforcing plies according to the invention fitted with the hose coupling according to the invention the reinforcing plies are staggered pair by pair before the swaging operation.

In the hose fitted with the coupling according the invention the length of individual staggered portions is approximately proportional to the sine of the medium angle of lay of the corresponding reinforcing ply pairs forming the staggered portions.

As it has been mentioned above, the ability of individual plies to bear axial forces depends on the angle of lay. According to the invention the length Lᵢ of individual staggered portions is chosen such that it is approximately proportional to the sine of the medium angle of lay βᵢ of the corresponding reinforcing plies forming the staggered portions. Medium angle of lay is taken as the arithmetic mean value of the angles of lay of the two reinforcing plies. “Approximately proportional” means that the value is between 0.8 and 1.2 times the proportional value, that is for the length of any two staggered portion

0,8≦(sinβᵢ/sinβⱼ)/(Lⱼ/Lᵢ)≦1,2 (1)

where: βᵢ, βⱼ is the medium angle of lay for each pair reinforcing plies, measured from the cross section perpendicular to the hose axis, and Lᵢ , Lⱼ is the length of the staggered portions of the individual reinforcing plies.

The inventive method for manufacturing a large-diameter hose fitted with a swaged coupling is characterized by that before swaging the cover of the hose is removed at the portion where the cover is connection with the ridges of the ridged outer ferrule of the hose coupling, and the hose liner and the optionally included load distribution textile ply or cord fabric ply are also removed from the hose end before swaging at a length not longer than the length of the staggered portion of the stem.

According to the method, in case hoses with four or more reinforcing plies are produced, the reinforcing plies are staggered pair by pair before the swaging operation.

### BRIEF DESCRIPTION OF THE DRAWINGS

The invention is explained in detail referring to the accompanying drawings, where

FIG. 1 shows the hose coupling after swaging as fitted to a hose having two reinforcing plies,

FIG. 2 is a magnified detail view of a portion of the stem of the coupling,

FIG. 3 shows a preferred embodiment of the hose coupling after swaging as fitted to a hose having two reinforcing plies, and

FIG. 4 shows the hose coupling after swaging, as fitted to a staggered hose having four reinforcing plies.

### DETAILED DESCRIPTION

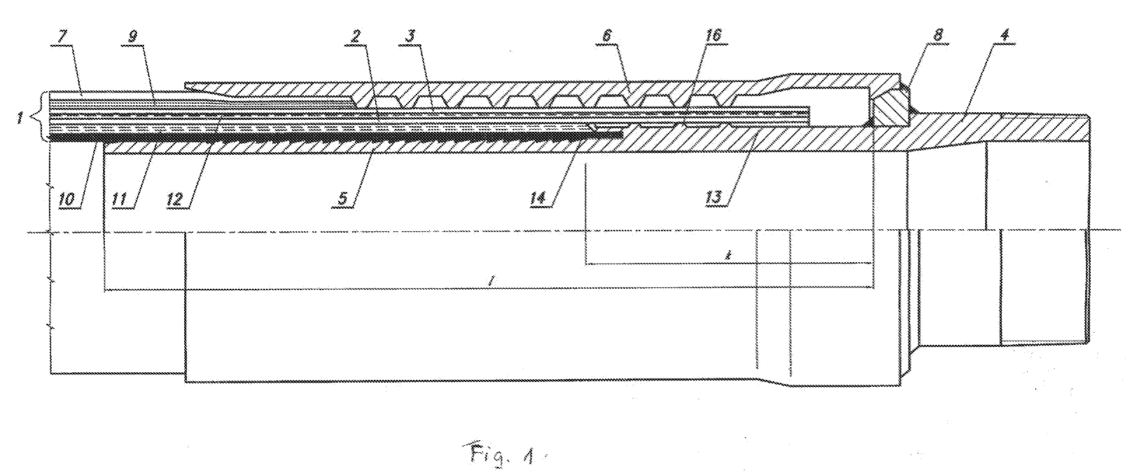

According to the preferred embodiment shown in FIG. 1 the hose 1 comprises two main reinforcing plies, the bottom steel cable ply 2 and the upper steel cable ply 3. (As it has already been mentioned, using the industry jargon we term the main reinforcing ply located closer to the hose axis the “bottom (steel cable) ply”). The fluid sealing layer of the hose 1 is constituted by a liner 10 that can for instance be made from rubber or sufficiently resilient plastic such as polyamide or a thermoplastic elastomer. Between the liner 10 and the bottom steel cable ply 2 one or more load distribution textile plies or cord fabric plies 11 are included. The steel cable plies 2, 3 are embedded in embedding rubber layers 12. A cover 7 reinforced by an optionally included rubberized cover textile 9 is disposed above the upper (outer) steel cable ply 3. The hose coupling 4 also has an inner stem 5 and a ridged outer ferrule 6 that are connected by a joint 8 against axial displacement. The joint 8 is implemented in a manner known per se, such as by welding (as shown in FIG. 1), but bolted joints and other suitable mechanical joints may also be applied. The joint 8 may already exist before swaging or may be created during the swaging operation. Before swaging the hose 1 is inserted between the stem 5 and the ridged outer ferrule 6 of the hose coupling. As it is customary in the state of the art, the cover 17 of the hose 1 is removed or at least thinned down in the area corresponding to the ridged portion of the ridged outer ferrule 6. The ridged outer ferrule 6 has ridges or lands that come into metal-to-metal contact with the upper steel cable ply 3 during swaging. A portion of the liner 10 of the hose 1 is in contact with the inner stem 5, but in another area the liner 10 and the optional load distribution plies 11 are removed. The inner stem 5 is serrated on the surface portion facing the hose body, the outside diameter of the stem 5 being approximately the same as the inside diameter of the hose 1. A shoulder 13 is disposed on the inner stem 5. The shoulder 13 has ridges, with its largest outside diameter being approximately the same as the free inside diameter of the bottom steel cable ply 2. The length of the shoulder 13 is greater or equal to the length of the portion from which the liner 10 and optional load distribution plies 11 have been removed. The end of the shoulder 13 that faces the hose is terminated in an undercut 14.

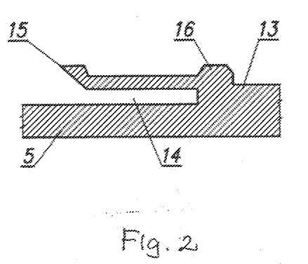

The undercut 14 disposed on the shoulder 13 is an essential feature of the invention. A preferred configuration of the undercut 14 is shown in a magnified detail view in FIG. 2. The shoulder 13 disposed on the inner stem 5 of the hose coupling is terminated at the end facing the hose in an undercut 14. A cutting edge 15 is disposed at the free end of the undercut 14. When the outer ferrule 6 of the hose coupling 4 is swaged, the liner 10 is subjected to high load that causes it to deform towards the load-free area that is not yet swaged. As swaging action approaches the cutting edge 15, the edge engages and cuts into the liner 10 and/or the optional load distribution plies 11, and the liner 10 gets caught in the undercut 14. In case the hose is put under internal pressure, the increased pressure in the liner 10 further presses the liner 10 into the undercut 14, effectively resulting in a self-sealing system. In specific cases the tight connection between the bottom steel cable ply 2 and the hose coupling 4 is provided by means of ridges 16 disposed on the shoulder 13. According to a preferred embodiment of the invention, after the swaging operation the ridges on the shoulder 13 lay in the same plane as some of the ridges of the outer ferrule 6.

Preferably, the length k of the shoulder 13 (measured from the cutting edge 15) is less than half of the length I of the stem. The length I of the inner stem 5 is measured from the location of the joint 8 where the outer ferrule 6 and the stem 5 are connected.

k<I/2 (2)

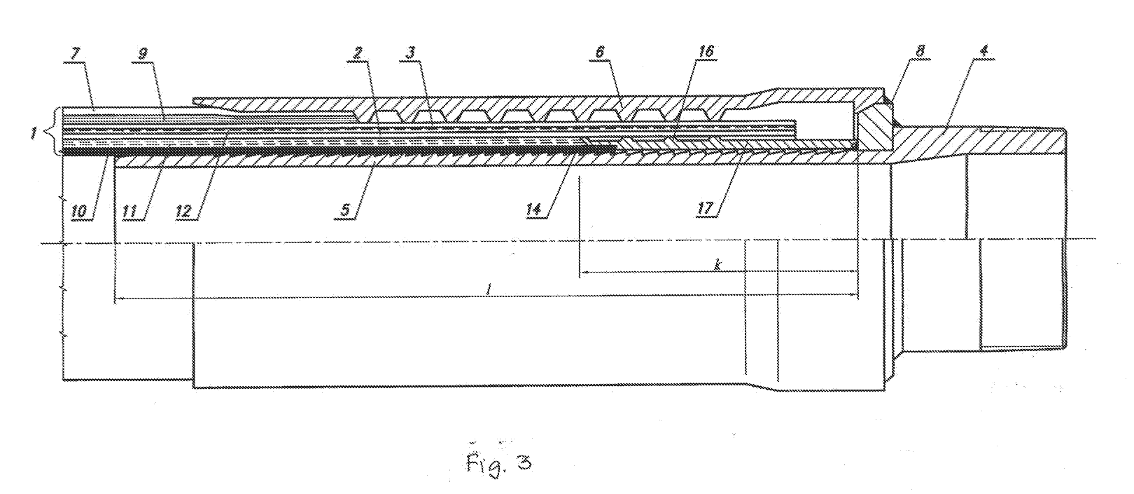

FIG. 3 shows a further preferred embodiment of the invention after swaging. This embodiment involves a hose having two reinforcing plies. In this case the arrangement according to the invention is implemented not through machining the shoulder 13 in the material of the stem 5 but by including an insert 17 placed in the hose coupling 4. The insert 17 is configured such that it can be pulled on the inner stem 5 of the hose coupling. During swaging the insert 17 gets firmly gripped on the inner stem 5. The undercut 14 is disposed at the end of the insert 17 that faces the hose 1. After swaging the material of the liner 10 fills the space of the undercut 14. A cutting edge 15 is also disposed on the insert 17.

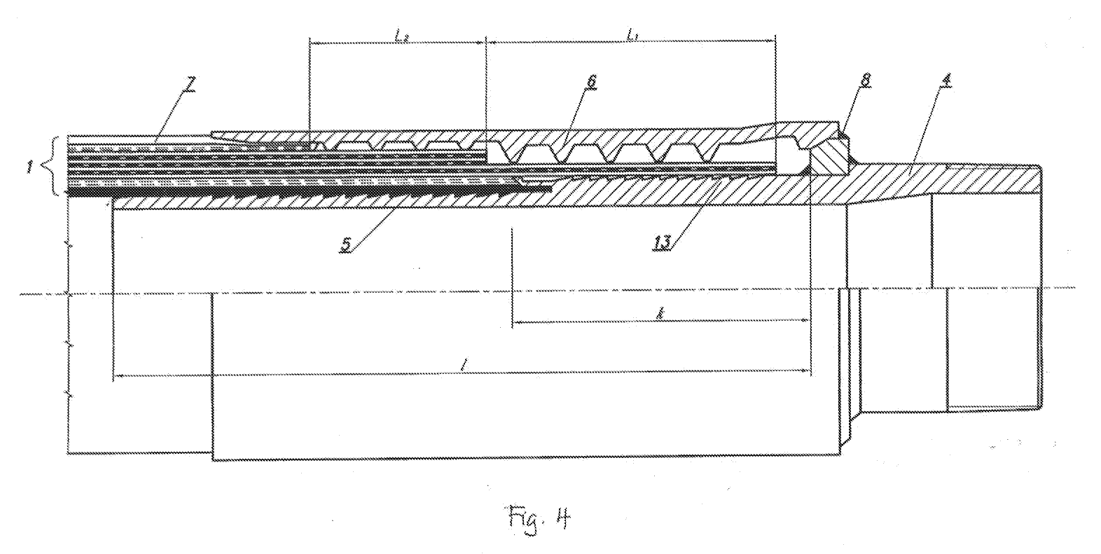

A further preferred embodiment of the invention is shown in FIG. 4. According to this embodiment, a hose coupling 4 having two staggered portions is fitted on a hose 1 comprising four reinforcing plies. Staggering of the plies was carried out pair by pair, with the length of the staggered portions being approximately proportional to the medium angle of lay of the reinforcing ply pairs satisfying inequality (1).

Further characteristics and advantages of the present invention are illustrated for easier comprehension by the following non-limiting description of actual examples.

### EXAMPLES

### Example 1

A high-pressure hose reinforced with two steel cable plies was fitted with a hose coupling according to the invention. The inside diameter of the hose was 90 mm, and the thickness of the liner 10 was 9 mm (including the rubberized load distribution textile plies). An insert 17 was pulled on the inner stem of the coupling 4. Three ridges 16 and a cutting edge 15 were formed on the insert 17. The inside diameter of the insert 17 was 90 mm, with its outside diameter being 106 mm at the top of the ridges 16 and at cutting edge 15. The overall length I of the insert 17 was 155 mm. The length k of the inner stem 5 as measured from the welded joint was 360 mm, and the outside diameter of the stem 5 was 89.7 mm, meaning that the insert 17 fitted with tight tolerance on the inner stem 5. FIG. 3 shows the schematic view of the hose end after the swaging operation, as fitted with the hose coupling 4.

The hose thus produced was subjected to pressure cycling at a gradually increasing temperature. At each temperature step 1000 cycles going between 3.5 and 35 MPa were performed. The following temperature steps were applied: 82° C., 90° C., 100° C., 110° C. The hose withstood pressure cycling well above the foreseen operating temperature of 82° C., with no relative displacement occurring between the coupling and the hose body.

In case the cutting edge 15 and the undercut 14 was formed from the material of the inner stem 5, this hose too withstood 1000 pressure cycles at 82° C.

### Example 2 (for comparison)

The high-pressure hose reinforced with two steel cable plies applied in Example 1 was fitted with a prior art swaged coupling. The hose coupling was identical to the one applied in Example 1 apart from not having the insert 17.

The hose fitted with the coupling was subjected to the same pressure cycling test that was applied in Example 1, with the pressure changing between 3.5 and 35 MPa. After 186 cycles the coupling got displaced relative to the hose and the hose began leaking.

### Example 3

A hose fitted with a coupling identical with the one applied in Example 1 was subjected to high-frequency pressure cycling for 10,000 cycles between 3.5 and 35 MPa. Cycle time was under 10 s. The hose was then subjected to pressure testing at 70 MPa for 4 hours, after which it was intentionally burst. The hose burst at a pressure of 99 MPa, but the coupling did not get displaced relative to the hose body.

### LIST OF REFERENCE NUMBERS

1 hose
2 bottom steel cable ply
3 upper steel cable ply
4 coupling
5 stem
6 ridged outer ferrule
7 cover
8 joint
9 rubberized cover textile
10 liner
11 load distribution textile ply or cord fabric ply
12 embedding rubber layer
13 shoulder
14 undercut
15 cutting edge
16 ridge
17 insert

What is claimed is:

1. A hose coupling for high-pressure hoses comprising:
a stem; and
a ridged outer ferrule connected to the stem;
wherein a staggered portion is disposed on the stem in the proximity of the connection of the stem and the ridged outer ferrule, where the diameter of the staggered portion is larger than the diameter of the stem, and the staggered portion has an undercut and a cutting edge.

2. The hose coupling according to claim 1, wherein the length of the staggered portion disposed on the stem is smaller than half of the length of a stem section extending between the end of the stem and the connection of the stem and the ridged outer ferrule.

3. The hose coupling according to claim 1, wherein the staggered portion, the cutting edge and the undercut are made from the material of the stem.

4. The hose coupling according to claim 1, wherein the staggered portion, the cutting edge, and the undercut are implemented as an insert that can be pulled on an outer peripheral surface of the stem.

5. The hose coupling according to claim 1, wherein the stem has a serrated staggered portion.

6. The hose coupling according to claim 5, wherein after swaging, teeth of the serrated staggered portion of the stem lie in the same plane as corresponding ridges of the ridged outer ferrule.

7. A high-pressure hose fitted with a swaged coupling according to claim 1, wherein before a swaging operation, a cover of the hose was removed at a portion where the cover had been in connection with ridges of the ridged outer ferrule of the coupling, with a hose liner and a load distribution textile ply or cord fabric ply being also removed from the hose end before swaging at a length not longer than the length of the staggered portion of the stem.

8. A hose comprising four or more reinforcing plies, fitted with the coupling according to claim 7, wherein reinforcing plies thereof are staggered pair by pair before the swaging operation.

9. The hose fitted with the coupling according to claim 8, wherein the length of individual staggered portions is approximately proportional to the sine of the medium angle of lay of the corresponding reinforcing ply pairs forming the staggered portions.

10. The hose fitted with the coupling according to claim 8, wherein for any two pairs of reinforcing plies, the following inequality stands
0,8≦(sinβᵢ/sinβⱼ)/(Lⱼ/Lᵢ)≦1,2
where:
βᵢ, βⱼ is the medium angle of lay of the reinforcing ply pairs, measured from the cross section perpendicular to the hose axis, Lᵢ, Lⱼ is the length of the staggered portions.

11. A method for manufacturing a large-diameter hose according to claim 7, the hose being fitted with a swaged coupling, wherein before swaging, the cover of the hose is removed at a portion where the cover is in connection with the ridges of the ridged outer ferrule of the hose coupling, and the hose liner and the load distribution textile ply or cord fabric ply are also removed from the hose end before swaging at a length not longer than the length of the staggered portion of the stem.

12. The method according to claim 11, wherein for manufacturing hoses having four or more reinforcing plies the reinforcing plies are staggered pair by pair before the swaging operation.
